(19) United States
(12) Patent Application Publication
(10) Pub. No.: US 2017/0157883 A1
(43) Pub. Date: Jun. 8, 2017

(54) COMPOSITE STIFFENER

(71) Applicants: Peter Sing, McCleary, WA (US); Andrew Chou Sing, McCleary, WA (US)

(72) Inventors: Peter Sing, McCleary, WA (US); Andrew Chou Sing, McCleary, WA (US)

(21) Appl. No.: 15/201,411

(22) Filed: Jul. 2, 2016

Related U.S. Application Data
(60) Provisional application No. 62/264,199, filed on Dec. 7, 2015.

(51) Int. Cl. B32B 3/12; B32B 15/04; B32B 21/04; B32B 5/18

(52) U.S. Cl. CPC B32B 3/12; B32B 5/18; B32B 15/046; B32B 21/047; B32B 2250/40; B32B 2307/544; B32B 2419/00; B32B 2479/00; B32B 2305/024; B32B 2305/022

(57) ABSTRACT

Embodiments of the disclosure are directed towards a composite stiffener that is incorporated into products to create stronger bonded and less warping sandwich panels. In addition, the stronger products can be lightweight.

### RELATED APPLICATIONS

This application claims priority under 35 U.S.C. Section 119(e) to U.S. Provisional Application Ser. No. 62,264,199, filed Dec. 7, 2015 entitled “Composite Panel Stiffener,” the disclosure of which is incorporated by reference herein in its entirety.

### BACKGROUND

Solid panels, composite panels, sandwich panels, tabletops, countertops, and doors made with any type of inner core material tend to warp, bend, or twist during the service life of the product. Prior solutions included adding, inserting or embedding steel rods, steel frames, even steel pipes in an effort to reduce warping, but this adds considerable weight to the end product which introduces a whole new set of problems. Aluminum tubes or extrusions are a lighter weight alternative to steel but also comes with its own set of challenges, especially sanding and gluing.

### SUMMARY

Embodiments of the disclosure are directed towards a composite stiffener that can be manufactured to create high precision true flat (truly flat) products that are less likely to warp, bend, or twist during the service life of the product. Embodiments of the composite stiffener include a uniquely designed stiffening material (in flat strips, boxes, rectangles or other shapes). The composite stiffener is positioned in various configurations either alone or along with any partial or complete core material of the composite panels to enhance the core strength of the resulting product. The addition of the composite stiffener to the core material or embedded in between layers of laminated material substantially increases the strength, preventing movement of flat building materials (skins) that would normally be subject to movement due to stress, regular use, or exposure to environmental conditions. The composite stiffener may function independently as a core material, or may be added to other core material to add toughness and rigidity to the other composite materials or skins. The composite stiffener may be placed in any configuration alone or with other material to achieve products that lay more flat with less risk of warp.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1E illustrate exemplary embodiments for a composite stiffener in accordance with the present disclosure;

FIGS. 2A-2C illustrate additional embodiments for a composite stiffener in accordance with the present disclosure;

FIG. 3A illustrates an exemplary panel that incorporates a configuration of composite stiffeners;

FIG. 3B illustrates another exemplary panel that incorporates another configuration of composite stiffeners;

FIG. 4 illustrates another view of a composite stiffener core inside a panel with exterior skins; and

FIG. 5 illustrates an exemplary beam that incorporates a configuration of composite stiffeners.

### DETAILED DESCRIPTION

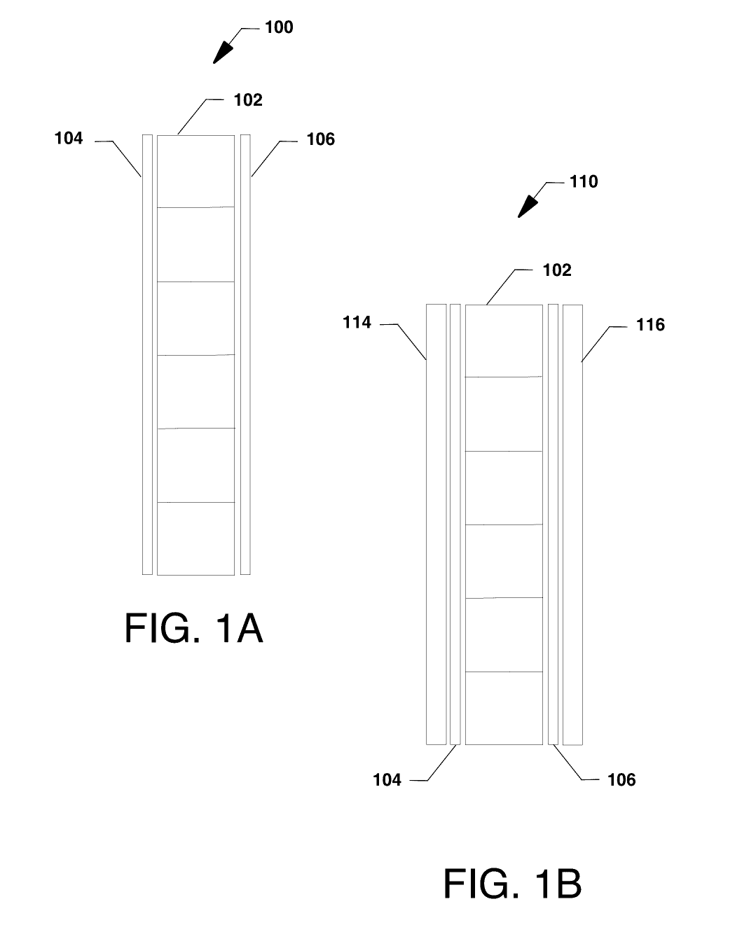

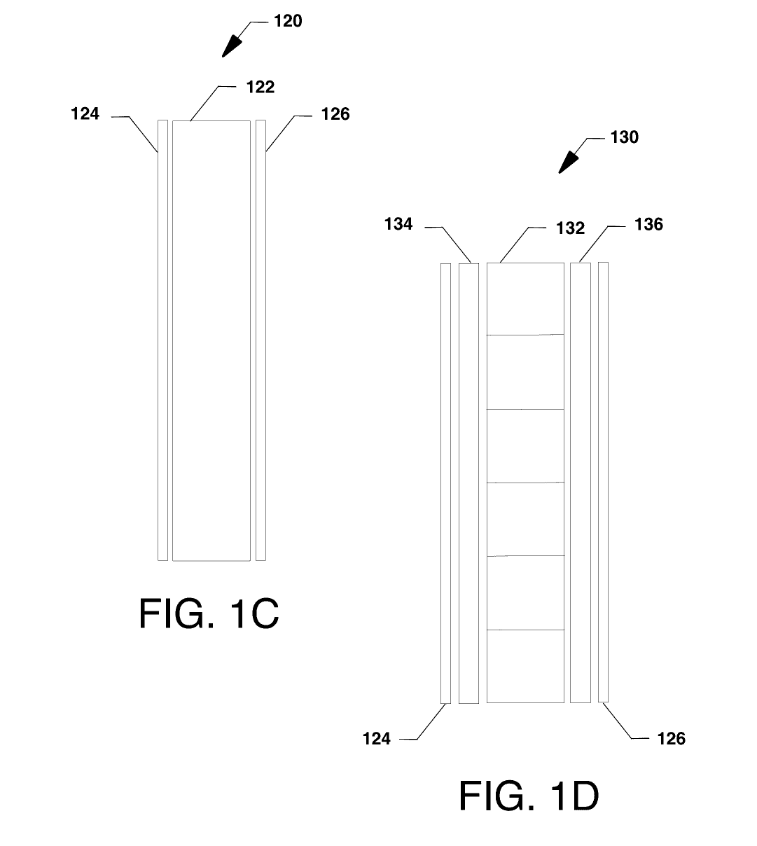

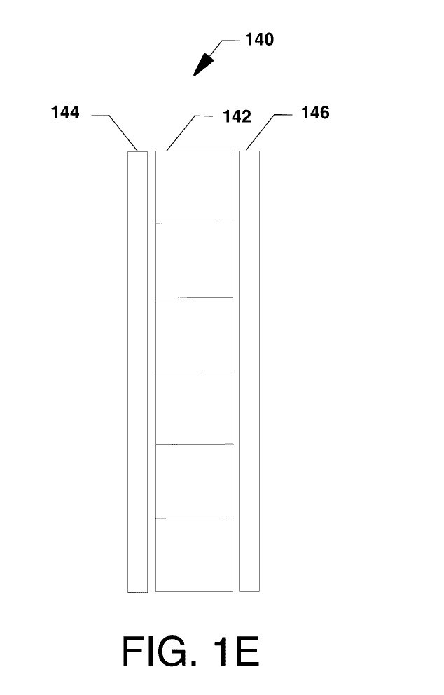

The following disclosure describes a composite stiffener for strengthening products. FIGS. 1A-1E illustrate exemplary embodiments for a composite stiffener in accordance with the present disclosure. The different embodiments illustrate some of the various combinations of layering composite stiffeners and flat building materials, including alternating metal (e.g., aluminum), natural (wood/plywood), or other composite materials. FIG. 1A illustrates an embodiment of a composite stiffener 100 that includes a core 102 and two strengthening strips 104, 106 positioned on opposite sides of the core 102. The material for the core 102 includes foam core, honeycomb core, paper core, plastic core, SING™ core manufactured by Sing Square Log Homes in McCleary, Wash., or other sandwiched flat building material. The two strengthening strips 104, 106 include aluminum, metal, or any other strengthening material. FIG. 1B illustrates an embodiment of a composite stiffener 110 that includes core 102 and two strengthening strips 104, 106 with an additional outside laminate layer 114, 116 over the two strengthening strips 104, 106. The outside laminate layer 114, 116 may include plywood or other material. FIG. 1C illustrates an embodiment of a composite stiffener 120 that includes a core 122, such as a solid core or foam core, with strengthening strips 124, 126 of a metal panel lamination. FIG. 1D illustrates an embodiment of a composite stiffener 130 that includes a core 132 with an inner layer 134, 136 layered on opposite sides of the core 132 and strengthening strips 124, 126 as an outer layer. In some embodiments, the inner layer 134, 136 includes plywood and the outer layer 124, 126 includes metal (e.g., aluminum panel lamination). FIG. 1E illustrates an embodiment of a composite stiffener 140 that includes a core 142 made of honeycomb core with a layer 144, 146 of plywood lamination on opposing sides. One skilled in the art will appreciate that different configurations of layers and materials may be used without departing from the scope of the present invention. For example, natural wood or plywood or a composite material may be used for one or more layers. The stiffening strip may comprise aluminum or any other material stiffener that provides strength.

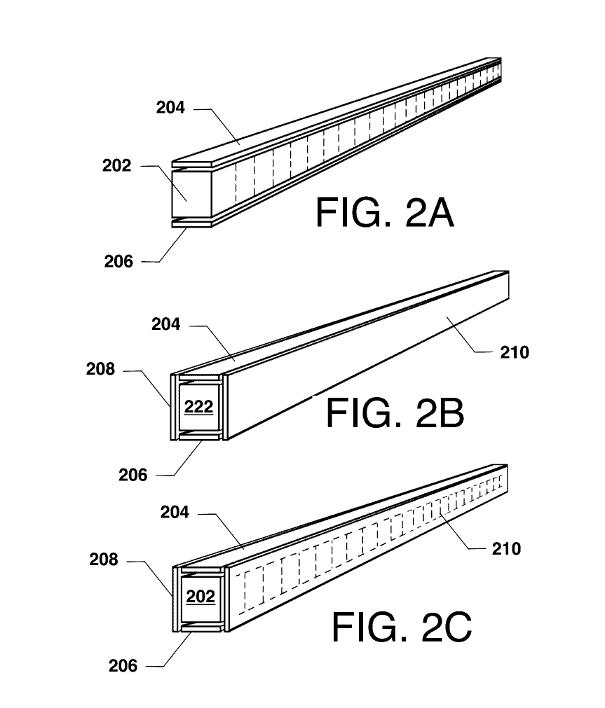

FIGS. 2A-2C illustrate additional views of embodiments for a composite stiffener in accordance with the present disclosure. FIG. 2A illustrates a composite stiffener 200 having a core 202 using SING™ core material or honeycomb core material. Composite laminate with plywood or other specified material is layered on top 204 and bottom 206 of core 202. FIG. 2B illustrates a composite stiffener 220 having a composite laminate with plywood on all four sides 204, 206, 208, 210 of core 222. The core 222 shown in FIG. 2B represents a solid core or foam core. FIG. 2C illustrates a composite stiffener 240 having a core 202 using SING™ core material or honeycomb core material and a composite laminate on all four sides 204, 206, 208, 210. The composite laminate is formed in strips for use as core material or slicing for composite layup of stiffeners. Plywood or other specified materials on the exterior provide a sand-able surface for controlling precision core thickness.

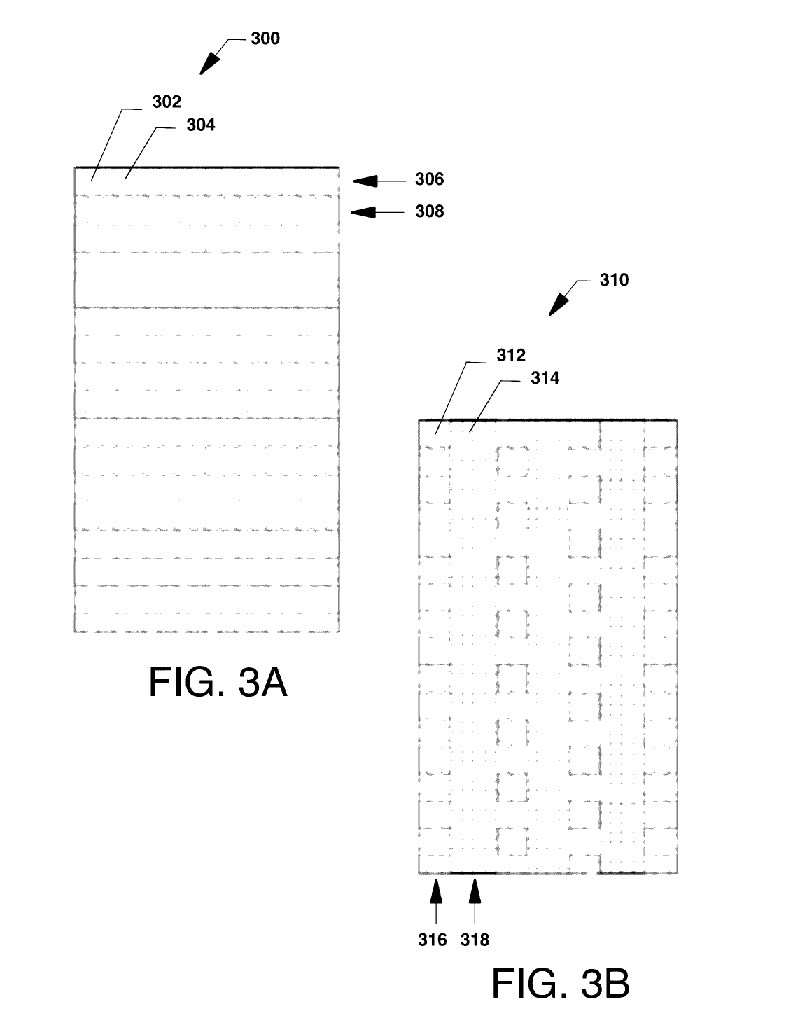

FIGS. 3A and 3B illustrates exemplary panels that incorporate various configurations of composite stiffeners. In these embodiments, the composite stiffener may be used as a core or sliced and used in a mosaic arrangement to strengthen the other core. The composite stiffener may be arranged in rows or in columns inside a composite panel or may be arranged in a non-repeating pattern. The embodiments allow the products to be sanded for high performance. Composite stiffener can be used in thick slices or blocks to act as a core itself, or in other embodiments, the stiffener can be used in combination with other core material in various configurations. In some embodiments, the composite stiffener may be either thin slices or thick blocks which may be used to replace other solid core material inside a panel (e.g., tabletop, countertop, door, and the like). FIG. 3A illustrates a composite stiffener 302, 304 arranged across the entire panel 300. For this embodiment, the composite stiffeners may be arranged in rows (e.g., rows 306, 308) to cover the entire product area. The individual composite stiffeners 302, 304 for each row 306, 308 may be offset between rows to provide additional strengthening. FIG. 3B illustrates another exemplary panel 310 that incorporates another configuration of composite stiffener 312. For this embodiment, the panel 310 may be configured having columns 316, 318, where alternating columns use composite stiffener 312 or composite material 314.

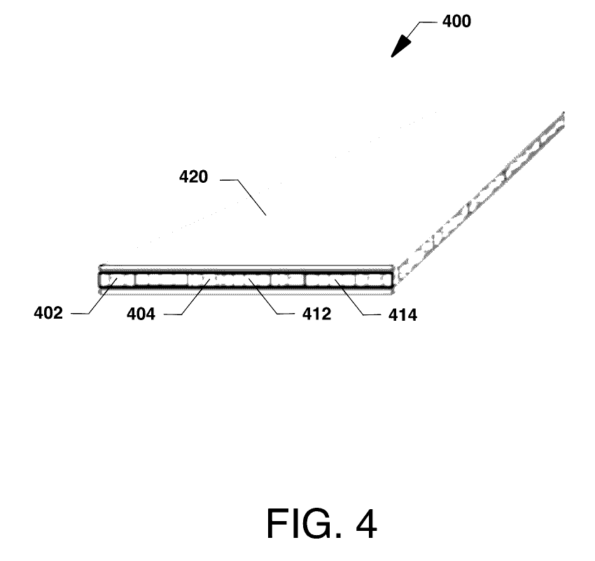

FIG. 4 illustrates another view of a composite stiffener inside a panel with exterior skins. In the embodiment shown in FIG. 4, a composite stiffener (e.g., composite stiffener 402, 404) and SING™ core 412, 414 combination panel 400 is configured with an exterior skin 420 applied to both the top surface and bottom surface (not shown).

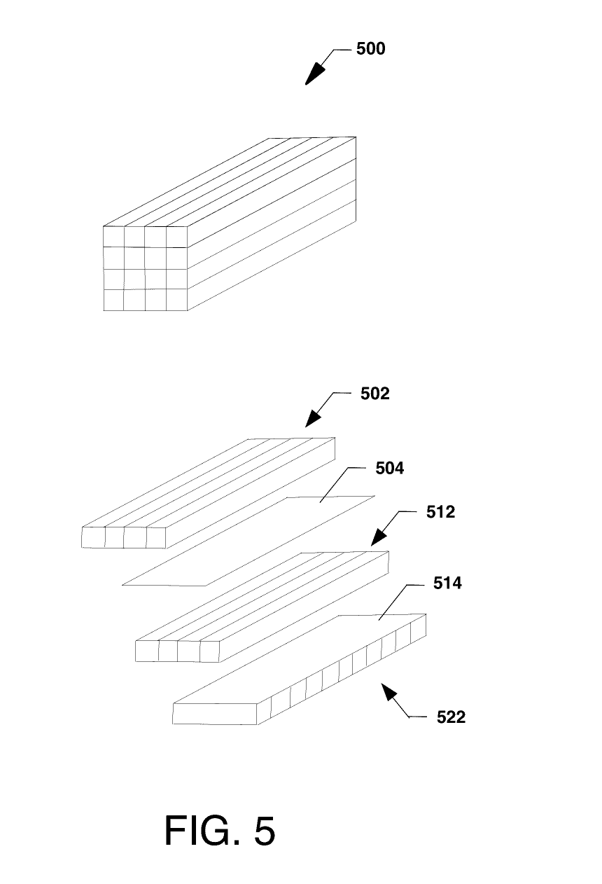

FIG. 5 illustrates an exemplary beam 500 that incorporates a configuration of composite stiffeners. Beam 500 may include several layers of composite stiffeners (e.g., composite stiffener layer 502, 512, and 522). The layers of composite stiffeners may all be aligned in the same direction (e.g., horizontal or vertical) or different layers may be aligned in different directions. For example, composite stiffener layer 522 is illustrated having a different orientation than composite stiffener layer 502 and 512. Between the composite stiffener layers, a skin (e.g., skin 504, 514) may be bonded to the composite stiffener top and/or bottom sides. Using this configuration of composite stiffeners a post or beam may be manufactured to any length, such as 20 feet, 40 feet, 100 feet, 200 feet or the like. The beam may be used for a sailing mast and other uses. Beam 500 may be manufactured using multiple layers of a single type of stiffener, such as stiffeners shown in FIGS. 1A-1E, or manufactured using multiple layers of a combination of different types of stiffeners. One skilled in the art will appreciate that other configurations of stiffeners than shown in FIGS. 1A-1E are envisioned using the teachings of the present application. Beams that are manufactured using the teachings of the present application may be used to replace wood, steel, concrete, aluminum, and other types of currently used beams, while providing superior strength and less cost. For example, in locations where lumber is scarce or expensive, beam 500 may be used for poles to carry communication and/or entertainment cables. Beam 500 may be used to replace steel structures in wind power applications. These and other applications too numerous to list are envisioned.

The composite stiffener may be designed as flat strips, boxes, rectangles, or any other shape. The addition of the composite stiffener increases the strength which helps prevent movement of flat building materials (skins) that would normally be subject to movement due to stress, regular use or exposure to environmental conditions. The composite stiffener may function independently as a core material, or as an addition to other composite material or skins in any configuration to add toughness and rigidity. In embodiments in which the composite stiffener is configured as flat strips, the flat strips may be made of different combinations of foam core, honeycomb core, paper core, plastic core, SING™ core, or other sandwiched flat building material with aluminum or any type of sheet goods material on each side or in between two or more surfaces or laminated materials. The elongated strip may be used as core material, implanted or installed inside, alongside, or adhered to any sandwich core, honeycomb core, other lightweight core material or substrate.

In some embodiments, the composite stiffener may be made of a combination of wood ply, plastic ply, metal or other sheet goods bonded together to encase (either partially or completely) a lightweight core material which include EPS foam, SING™ core, honeycomb core, or other lightweight core material in the center. The composite stiffeners (elongated inner panel support strips) may be glued as core material or combined with other core materials inside the sandwich panel. Exterior sheet goods (skins) are bonded to the top and bottom of the panels which completes the enclosed box structure (or composite torsion box) with grids between the composite strips. These reinforced composite structure grids lock-in the two surface skins. The composite stiffener provides strength in sandwich panel walls that prevent buckling, a common problem associated with walls made of aluminum, plastic, metal, wood, and/or any combination thereof.

In the past, solutions included adding, inserting or embedding steel rods, steel frames, even steel pipes in an effort to reduce warping, but this adds considerable weight to the end product which introduces a whole new set of problems. Aluminum tubes or extrusions are a lighter weight alternative to steel but also comes with its own set of challenges, especially sanding and gluing.

Neither steel or aluminum are as effective or strong as the composite stiffener as described in the present application. By alternating and implementing a composite box system, as that of the composite stiffener, including metal and wood materials, a better bonding surface is achieved for better adherence to the two surface skins, thus reducing delamination. In embodiments with composite stiffeners using aluminum as the metal component in the structure design as wells as wood and/or plastic material(s) makes this unique material easy to saw, sand and glue.

In accordance with the present application, base core material may include any specified core or substrate material including (but not limited to) any rigid foam material, honeycomb core, SING™ Core, natural, synthetic or metal based core or substrate material. Composite strips to create the box mosaic may include at least two pieces of any sheet goods (flat building material) to include wood fiber-based sheet goods, metal (including aluminum) or building materials made of any other natural or synthetic material or combination thereof. In accordance with the present application, a sandwich panel is a panel that includes two or more stress skins made of any surface material attached to either side of a core material. The core material could be any material including honeycomb core structure made of any material such as paper, cardboard, aluminum, plastic or any other conceivable material and/or design. Core material includes solid materials such as wood or wood products, and may even include a hollow core.

While the foregoing written description of the invention enables one of ordinary skill to make and use a product incorporating a composite stiffener as described above, those of ordinary skill will understand and appreciate the existence of variations, combinations, and equivalents of the described embodiments, methods, and examples herein. Thus, the invention as claimed should therefore not be limited by the above described embodiments, methods, and examples, but by all embodiments and methods within the scope and spirit of the claimed invention.

The claimed invention is:

1. A composite stiffener comprising:
a set of strengthening strips, each strengthening strip comprising a rigid material; and
a core having a plurality of sides, wherein the strengthening strips are bonded to at least two of the plurality of sides of the core.

2. The composite stiffener of claim 1, wherein the core comprises a honeycomb core.

3. The composite stiffener of claim 1, wherein the core comprises a foam core.

4. The composite stiffener of claim 1, wherein the rigid material comprises a plastic sheet.

5. The composite stiffener of claim 1, wherein the rigid material comprises an aluminum sheet.

6. The composite stiffener of claim 1, wherein the rigid material comprises a wood-based sheet.

7. The composite stiffener of claim 1, further comprising an outer laminate bonded to each outer side of the set of strengthening strips.

8. A composite stiffener comprising:
a set of strengthening strips, each strengthening strip comprising a rigid material;
a set of inner laminate layer; and
a core having a plurality of sides, wherein each inner laminate layer is bonded to one of at least two of the plurality of sides of the core and each set of strengthening strips is bounded to an outer side of each of the inner laminate layers.

9. The composite stiffener of claim 8, wherein the core comprises a honeycomb core.

10. The composite stiffener of claim 8, wherein the core comprises a foam core.

11. The composite stiffener of claim 8, wherein the rigid material comprises a plastic sheet.

12. The composite stiffener of claim 8, wherein the rigid material comprises an aluminum sheet.

13. The composite stiffener of claim 8, wherein the rigid material comprises a wood-based sheet.

14. The composite stiffener of claim 8, wherein the inner laminate layer comprises a wood-based sheet.

15. A composite panel comprising:
a plurality of composite stiffeners, wherein each composite stiffener comprises a set of strengthening strips and a core having a plurality of sides, wherein each strengthening strip comprises a rigid material and the strengthening strips are bonded to at least two of the plurality of sides of the core.

16. The composite panel of claim 15, further comprising a plurality of core sections wherein the plurality of composite stiffeners are dispersed alongside the plurality of core sections.

17. A composite beam comprising:
a plurality of composite stiffeners stacked on top of each other to create a desire length, wherein each composite stiffener comprises a set of strengthening strips and a core having a plurality of sides, wherein each strengthening strip comprises a rigid material and the strengthening strips are bonded to at least two of the plurality of sides of the core.

18. The composite beam of claim 16, wherein the plurality of composite stiffeners are stacked uniformly in a same direction.

19. The composite beam of claim 16, wherein the plurality of composite stiffeners are stacked in perpendicular layers.
